(19) United States
(12) Patent Application Publication
(10) Pub. No.: US 2004/0145760 A1
(43) Pub. Date: Jul. 29, 2004

(54) Font downloading apparatus and method

(75) Inventor: Tsuneaki Kurumida, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/626,589

(22) Filed: Jul. 25, 2003

(30) Foreign Application Priority Data
Jul. 31, 2002 (JP) 2002-223581

(51) Int. Cl. G06F 15/00

(52) U.S. Cl. 358/1.11; 358/1.15

(57) ABSTRACT

The present invention relates to a font downloading apparatus and method which can download fonts of a coding scheme not supported by a printer after converting them into a supported coding scheme. When a user on a host computer selects a printer to which a font is to be downloaded, the system acquires coding schemes supported by the selected printer. Then, when a font to be downloaded is specified, the system acquires the coding scheme of the font. If the font to be downloaded is not supported by the printer, the system makes the user to select one of the acquired coding schemes, converts the codes of the font to be downloaded to the selected coding scheme, and downloads the font to the printer.

### FIELD OF THE INVENTION

The present invention relates to a font downloading method and apparatus for printing devices and the like connected, for example, to a network.

### BACKGROUND OF THE INVENTION

Conventionally, in the use of downloaded fonts, it has been common practice to convert character codes in print data according to the character coding scheme of the downloaded fonts as described in Japanese Patent Laid-Open No. 8-106524. Another practice involves downloading fonts after converting them into a specific character coding scheme to allow for printing fonts which belong to an incompatible coding scheme, as exemplified by external character processing described in Japanese Patent Laid-Open No. 11-20244.

However, according to the conventional methods described above, even if Arabic fonts, for example, are downloaded to a printer intended for use in Western Europe, they cannot be printed if the printer does not support Arabic languages. Although they can be made printable if converted into a specific coding scheme as is the case when external characters are processed, this presents the following problems:

When two or more printers are used, it is not always possible to download a font to all the printers using the same specific coding scheme.

If a font is downloaded after being converted into a common coding scheme supported by all the printers, the target coding scheme is often the most frequently used coding scheme. This makes a great impact on the system. For example, when a font is downloaded, frequently used characters may be replaced by downloaded counterparts, resulting in unintended characters being printed or in disturbed character spacing.

### SUMMARY OF THE INVENTION

The present invention has been made in view of the above problems. Its object is to provide a font downloading method and apparatus which can convert fonts of a coding scheme not supported by character/image forming equipment such as a printer into a supported coding scheme to be downloaded, and thereby make it possible to download and use fonts of a coding scheme specified by a user without affecting normal operation of the equipment.

To achieve the above object, the present invention provides an apparatus for downloading fonts to a character output apparatus, comprising:

a selector for allowing one of character coding schemes supported by the character output apparatus to be selected if the character coding scheme of the fonts cannot be used on the character output apparatus;

a converter for converting the character coding scheme of the fonts into the character coding scheme selected via the selector; and

a downloader for downloading the fonts whose character coding scheme has been converted by the converter onto the character output apparatus.

This configuration allows the character output apparatus to use fonts it cannot normally use and allows the user to select the fonts to be used. This prevents output characters from being garbled.

Preferably, the font downloading apparatus comprises: an acquisition unit for acquiring coding schemes supported by the character output apparatus from the character output apparatus; and a determination unit for determining that the character coding scheme of the fonts cannot be used by the character output apparatus if the coding schemes acquired by the acquisition unit do not contain the character coding scheme of the fonts.

This configuration allows supported character coding schemes to be acquired directly from the character output apparatus, preventing selection errors.

Preferably, the font downloading apparatus further comprises: a storage for storing the type of the character output apparatus and character coding schemes supported by the character output apparatus by associating them with each other; and a determination unit for determining that the character coding scheme of the fonts cannot be used by the character output apparatus if the character coding schemes associated with the character output apparatus do not contain the character coding scheme of the fonts.

By storing the character coding schemes supported by the character output apparatus, this configuration makes it possible to prevent an unsupported character coding scheme from being selected, eliminate the need for communications procedures for acquiring character coding schemes, and thus reduce processing time.

Other objects, features, effects and advantages of the present invention will be apparent from the following description, taken in conjunction with the accompanying drawings, in which like reference characters designate the same or similar parts throughout the figures thereof.

### BRIEF DESCRIPTION OF THE DRAWINGS

FIG. 1 is a diagram showing a system which contains a downloader according to the present invention;

FIG. 2 is a flowchart showing a download operation performed by the downloader according to the present invention;

FIG. 3 is a conceptual diagram showing font conversion performed by the downloader according to the present invention;

FIG. 4 is a diagram showing code conversion tables of the downloader according to the present invention;

FIG. 5 is a diagram showing a screen of the downloader according to the present invention;

FIG. 6 is a flowchart showing a download operation performed by a downloader according to a second embodiment of the present invention; and

FIG. 7 is a diagram showing information about correspondence between machine names and supported coding schemes, held by the downloader according to the present invention.

### DETAILED DESCRIPTION OF THE PREFERRED EMBODIMENTS

[First Embodiment]

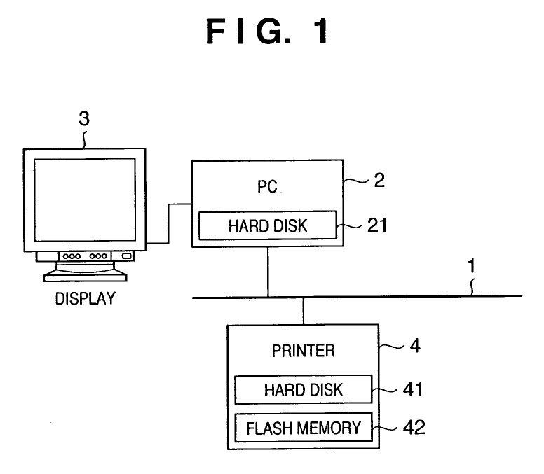

FIG. 1 is a diagram best describing characteristics of a system which employs a downloader according to the present invention. A configuration of the system which employs the present invention will be described with reference to the drawing.

In the figure, a network 1 mutually connects a personal computer (hereinafter abbreviated to PC), printers, etc. The PC 2 is connected with a CPU, a RAM, a ROM, various interfaces (IFs) via a system bus (not shown). A hard disk drive 21 is connected to the bus or an IF of the PC 2 and holds programs run on the PC 2 and data used by the programs. The hard disk drive 21 also stores the downloader according to the present invention as well as downloaded data such as fonts. A display unit 3 such as a CRT or liquid-crystal monitor creates displays according to programs running on the PC. A printer device 4 consists of a data processor, print engine, network IF, ROM, RAM, etc. A hard disk drive 41 used by the printer 4 is connected to the bus or an IF of the printer 4 and holds programs run by the printer 4, print data processed by the programs, fonts, form overlay data, macro data, etc. A flash memory device 42 used by the printer 4 is connected to the bus or an IF of the printer 4 and holds programs run by the printer 4, fonts, form overlay data, macro data, etc.

Font data held by the printer 4 includes a glyph table which contains glyph data for expressing characters visually and internal code table which associates specific glyphs with character codes. During printing, an internal code is searched and retrieved from the internal code table using a given code, and glyph data corresponding to the internal code is acquired from the glyph table. Then, character image data is generated using the acquired glyph data and laid out in specified locations on output pages. The internal code registered in the internal code table is Unicode in the case of the printer according to this embodiment. Thus, the internal code table is required to convert the coding scheme of fronts desired to be used on the printer into the internal coding scheme, i.e., Unicode.

In this system, the downloader is implemented as a program which is stored as a program file on the hard disk of the PC 2 and read into the RAM and executed by the CPU at run time.

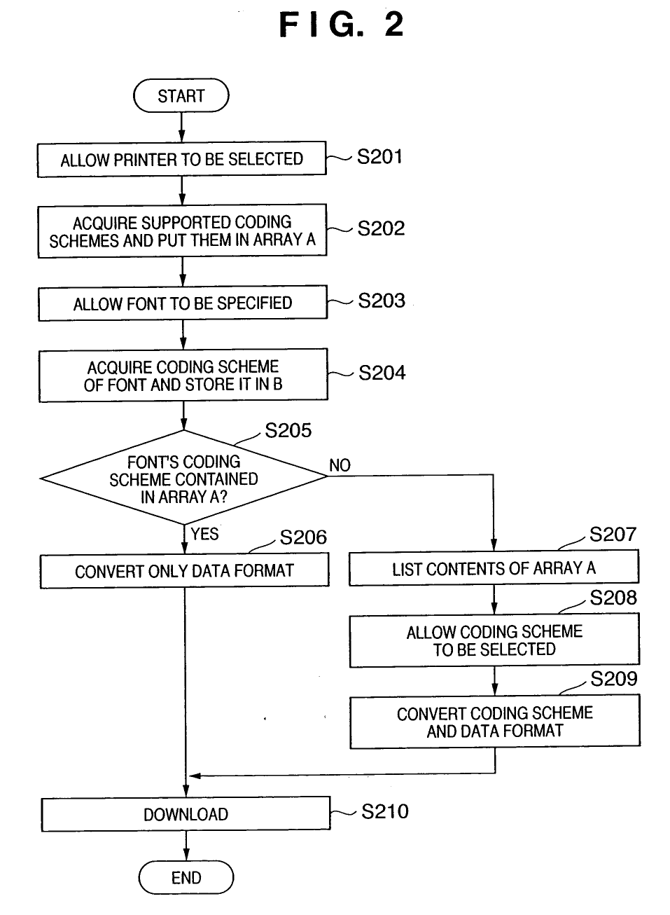

FIG. 2 is a flowchart showing operation of the downloader according to the present invention. The operation of the downloader will be described with reference to the drawing.

The downloader is stored in the hard disk drive 21 shown in FIG. 1. It is loaded into the RAM and executed by the CPU at run time.

Incidentally, according to this embodiment, the fonts downloaded are outline fonts in Apple Computer's TrueType format, the printer is a PCL printer (PCL is a page description language developed by Hewlett-Packard Co.), the information acquisition and download protocol is JL (Job Language), the coding scheme supported by the printer is constituted by character strings used in PCL's select commands. PCL assigns character strings to coding schemes in select commands as follows: it assigns 19U to Windows Latin1, and 2N to Latin2. That is, when sending a print command written in PCL from the personal computer 2 to the printer to make the printer do printing, the coding scheme to be used can be specified in a select command. For example, if “19U” is selected, this means that “Windows Latinl” is specified.

Referring to FIG. 2, in Step S201, a printer is selected for downloading. It is selected from a list of printers connected to the network. A list of printers can be obtained, for example, using a device listing function provided by the operating system. The operator can specify a specific printer in the printer list. The specified printer is selected as the printer for downloading.

In Step S202, a list of coding schemes supported by the selected printer is acquired from the printer and held in memory. According to this embodiment, the printer is connected to the personal computer 2 via bidirectional communications. When a predetermined command is issued to the printer by the personal computer 2, the printer returns a list of supported coding schemes to the personal computer 2. The personal computer 2 receives and holds the list. The list of supported coding schemes is in an array format and the array will be referred to as array A. The coding schemes may be returned as character strings Latin1, Latin2, JISX0208, and the like or as code page numbers such as those used by Microsoft Windows (registered trademark) and the like. Anyway, any format may be used within the system as long as it allows comparison with font coding schemes described later. The identifiers such as character strings or numbers which represent the acquired coding schemes are stored in the array beginning with index 0. In the above example, they are stored as A[0]=“Latin1”, A[1]=“Latin2”, A[2]=“JISX0208”.

In Step S203, the operator is made to specify the font to be downloaded. The specified font is stored. The fonts available to be specified are computer resources managed by the operating system of the personal computer 2. Fonts are selected, for example, from a font list by the operator, and thereby specified. Alternatively, downloadable fonts may be stored in a file storage as normal data files, from which the operator may be allowed to select a desired one. In either case, the selected font is marked for downloading.

In Step S204, the identifier of the coding scheme is extracted from the specified font and stored in a memory area B. Fonts are normally stored as files (font files) and the coding scheme of a font is recorded in the header of the font file. This makes it possible to know the coding scheme of a font when the font is used. The identifier of the coding scheme stored in the memory area B has the same format as the coding schemes stored in array A.

The coding scheme of a font may be Unicode or a specific 1-byte or 2-byte coding scheme. However, it is assumed here that the font to be downloaded has been created in a 1-byte coding scheme. The specific 1-byte coding scheme may be Code Page 850, Symbol, or Code Page 846 Latin/Arabic, for example. Each graphic character (excluding control characters) is assigned one of numeric values 0 to 255, which can be expressed by one byte (one octet). Even in 2-byte or other multi-byte character coding schemes, characters are treated in a basically similar manner although each character is represented by two or more bytes.

Incidentally, fonts created in Unicode contain information as to in what coding schemes they can be used. Thus, when downloading fonts created in Unicode, they can be treated similarly to fonts in the 1-byte coding schemes described above if the coding scheme for downloading is selected from among the coding schemes described in the font files as being supported.

In Step S205, it is determined whether array A which hold the coding schemes supported by the printer contains the font's coding scheme stored in the memory area B. If the font's coding scheme is contained, the flow goes to Step S206. Otherwise, the flow goes to Step S207.

In Step S206, since the coding scheme of the font to be downloaded can be used as it is on the printer, only the format of font data is converted into a downloadable format. Normally, TrueType fonts are not printed if downloaded as they are to a printer. Thus, they must be converted into a format which can be processed by the printer. For example, before TrueType fonts can be downloaded to a PCL printer, Symbol Set information (character code information), spacing information, and other information used by PCL must be generated from data contained in the TrueType fonts, unnecessary information such as information referenced only by Windows or PostScript must be deleted, TrueType character pattern data as well as tables needed to develop TrueType character patterns must be converted into a format downloadable to the PCL printer, and control codes necessary for downloading must be added.

On the other hand, in Step S207, since the coding scheme of the font to be downloaded cannot be used as it is on the printer, the coding scheme is converted before downloading. First, the list of the coding schemes supported by the printer is taken out of array A and displayed on the display unit 3 of the personal computer 2. In Step S208, the operator is allowed to select one of the listed coding schemes using a keyboard or the like. The coding scheme selected by the operator is stored.

In Step S209, the character codes of the font to be downloaded are converted according to the selected and stored coding scheme and their data format is converted into a format supported by the printer.

In Step S210, the font converted into a supported format in Step S206 or Step S209 is downloaded, and the processing is finished. As described above, this embodiment uses Unicode as the internal code. In the conversion of a coding scheme, characters to be downloaded are assigned Unicode characters which can be converted into character codes belonging to a specific coding scheme (e.g., Latin1).

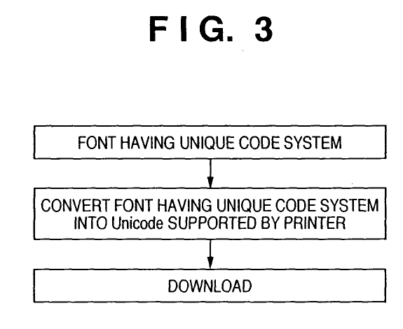

FIG. 3 is a diagram showing a font conversion process (Step S209 in FIG. 2). In FIG. 3, a font in a unique format is converted into Unicode supported by the printer before downloading. For example, a Tibetan font created in a 1-byte internal code cannot be printed on a printer generally used in Europe or the USA even if it is downloaded as a Unicode font or 1-byte Tibetan font. Even in that case, the Tibetan font can be used if the Tibetan character codes are converted, for example, into a coding scheme supported by the printer, such as ASCII or Latin1 generally used in Europe and America. The target coding scheme can be selected by the user in Step S203 in FIG. 2, but at least it must not be the one used with the font to be downloaded.

For example, in a system which usually use Roman8, the Latin1 coding scheme is rarely used for printer fonts, which belong to Roman8 in most cases. Thus, if the Tibetan language is downloaded to the printer in the Latin1 coding scheme, printing of other documents is not affected. Thus, the Tibetan language can be downloaded in the Latin1 coding scheme and subsequently Latin1 can be selected only when the Tibetan language is needed.

Then, to use the Tibetan language in the Latin1 coding scheme, the Tibetan language can be converted together with Unicode which can be converted into Latin1. At the time of printing, if Latin1 is selected using a select command of the PCL page description language, 1-byte character codes contained in the subsequent print data are printed in the Tibetan font.

Incidentally, if a user uses Roman8 and Latin1, but does not use Cyrillic (Russian Alphabet) and if his/her printer supports Cyrillic, he/she can download the coding scheme of the Tibetan font by converting it into Unicode used by Cyrillic. The downloaded font can be used for printing if selected as a font belonging to the coding scheme selected at the time of downloading. Specifically, if the coding scheme of the Tibetan font is converted into Cyrillic for downloading, the “Cyrillic” coding scheme can be selected using the select command of Printer Control Language (PCL). This allows Tibetan characters to be used as a font of the Cyrillic coding scheme supported by the printer. Incidentally, if a coding scheme contains two or more fonts belonging to the same font family, to identify a downloaded font, other font attributes (character size, style. etc) can be used together for selection.

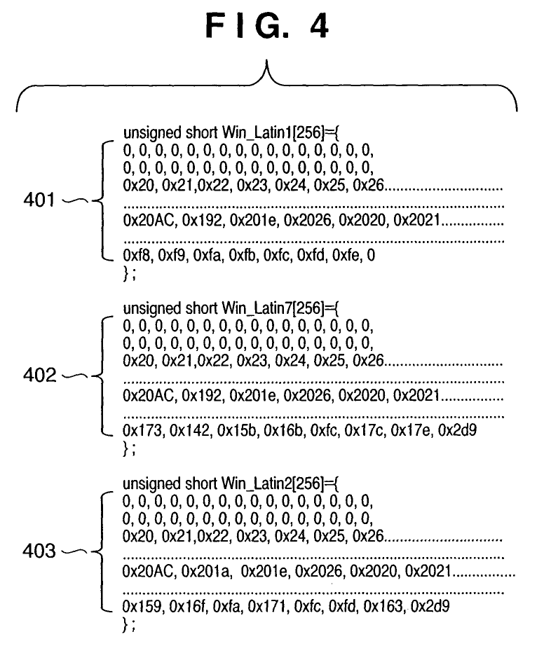

FIG. 4 is a diagram showing an example of font conversion table. In FIG. 4, Win_Latin1 consists of 256 codes (codes represented by 0 to 255). In table 401 in FIG. 4, the comma-separated numeric values enclosed by braces { } are individual character codes in Unicode. The numeric values other than 0 are Unicode character codes of corresponding Latin1 character codes. Specifically, the positions in the table represent Win_Latin1 character codes and the values at the respective positions represent the pre-conversion Unicode character codes for the corresponding Latinl character codes. For example, the euro currency symbol is represented by 128 (0x80 in hexadecimal) in Win_Latin1 and by 0x20AC in Unicode, and thus the 128th position in the Win_Latin1 contains a hexadecimal number 0x20AC. Therefore, the character pattern assigned to 0x20AC in Unicode by the conversion table can be printed as 128 (0x80 in hexadecimal) in Win_Latin1.

Thus, according to this embodiment, to assign a font of another coding scheme to the Win_Latin1 coding scheme, the character patterns can be redefined according to the table in FIG. 4. For example, the character pattern which needs to be printed as 0x80 can be downloaded by assigning it to the code 0x20AC instead of the euro currency symbol.

The downloader of the personal computer stores as many similar conversion tables (e.g., tables 402 and 403 in FIG. 4) as there are coding schemes which are supported by the printer and likely to be downloaded. If the system can acquire the conversion tables in FIG. 4 from the printer, it is also possible to upload them from the printer when they are used.

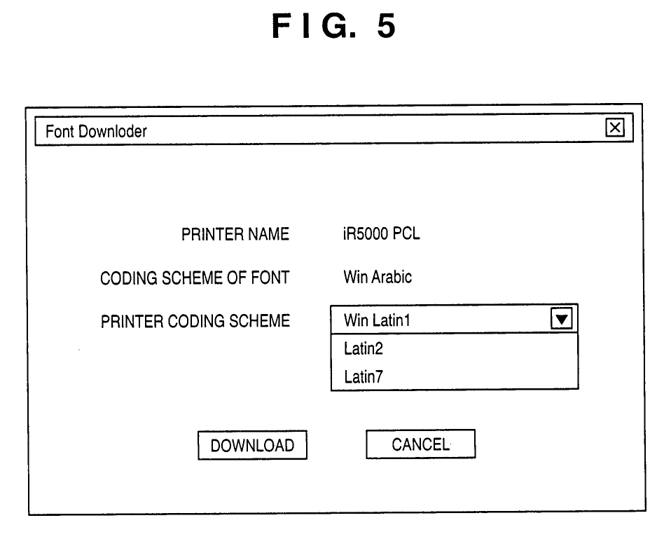

FIG. 5 shows a user interface screen of the downloader. As shown in the figure, a font belonging to the Win Arabic coding scheme (not supported by connected iR5000 PCL printers) is going to be downloaded. There are three coding schemes supported by the iR5000 PCL printers: Win Latin1, Latin2 and Latin7. When the operator selects one of them and clicks on a Download button, the selected coding scheme is downloaded according to procedures of the flowchart shown in FIG. 2 after the Win_Arabic character patterns are assigned, as a font belonging to the selected coding scheme, to Unicode which will be converted into the selected coding scheme within the printer.

As described above, by acquiring a downloadable character coding scheme (internal code table) from the printer and converting the coding scheme of fonts not supported by the printer into the acquired coding scheme before downloading, it is possible to print characters which normally cannot be printed.

[Second Embodiment]

Regarding FIGS. 1, 3, 4, and 5, this embodiment is the same as the first embodiment. However, as data on available printers, the personal computer 2 holds a list of coding schemes supported by the printers.

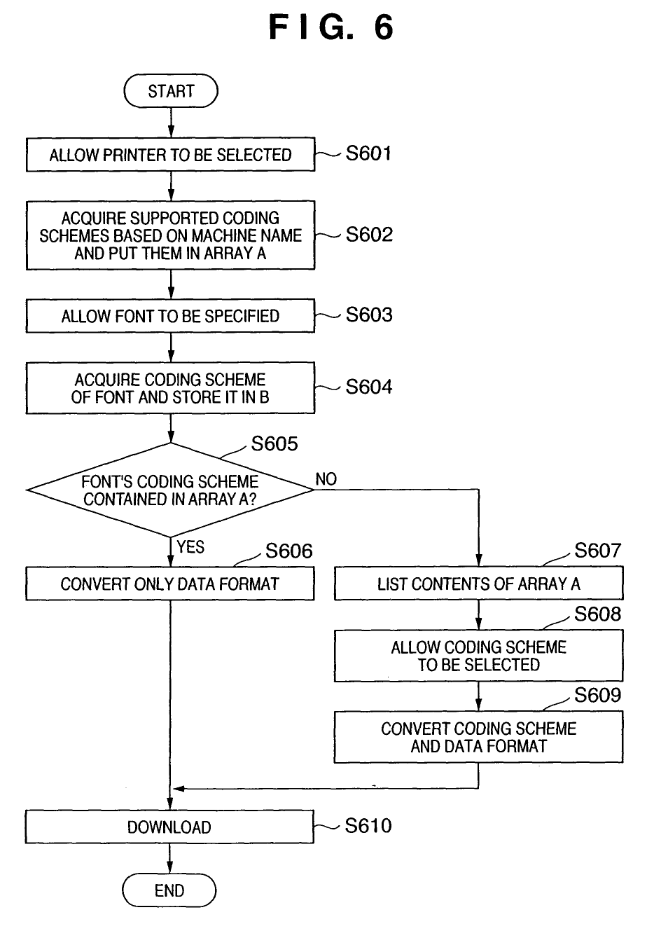

FIG. 6 is a flowchart showing operation of a downloader according to the present invention. This downloader operates in the system shown in FIG. 1. When the operator selects a printer in Step S601, supported coding schemes are extracted based on the model name in Step S602. The extracted coding scheme information is held in array A. Steps S603 to S610 correspond, respectively, to Steps S203 to S210 in FIG. 2. Operations in these steps have already been described in the first embodiment, and thus description thereof will be omitted here. These procedures make it possible to download and use fonts belonging to a coding scheme not supported by the printer after converting them into a coding scheme supported by the printer.

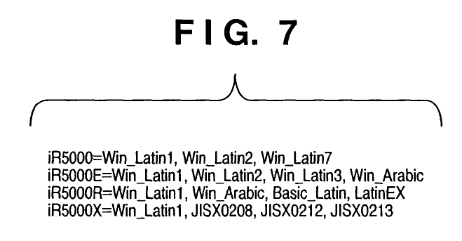

FIG. 7 shows stored data about correspondence between machine names of printers and supported coding schemes as it is displayed in text form. For example, if the printer name is iR5000R, character coding schemes Win_Latin1, Win_Arabic, Basic_Latin, LatinEX are available. As can be seen from the figure, given a model name, supported coding schemes can normally be known. According to this embodiment, the downloader can in advance possess the type of information that must be acquired from printers in the case of the first embodiment.

By making the downloader hold the model names of printers and supported coding schemes associated with them, it is possible to incorporate necessary code conversion tables (shown in FIG. 4) into the downloader in advance without omission. Besides, only the codes that can be used definitely can be presented to the user because codes for which there is no code conversion table are not marked as available and are not specified by the user.

Incidentally, the present invention may be applied either to a system consisting of two or more apparatus (e.g., a host computer, interface devices, a reader, a printer, and the like) or to equipment consisting of a single apparatus (e.g., a copier, a facsimile machine, or the like).

Also, the object of the present invention can be achieved by a storage medium (or recording medium) containing the software program code that implements the functions of the above embodiments: it is supplied to a system or apparatus, whose computer (or a CPU or MPU) then reads the program code out of the storage medium and executes it.

In that case, the program code itself read out of the storage medium will implement the functions of the above embodiments, and the program code itself and the storage medium which stores the program code will constitute the present invention.

Also, the functions of the above embodiments may be implemented not only by the program code read out and executed by the computer, but also by part or all of the actual processing executed, in accordance with instructions from the program code, by an operating system (OS) or the like running on the computer.

Furthermore, the functions of the above embodiments may also be implemented by part or all of the actual processing executed by a CPU or the like contained in a function expansion card inserted in the computer or a function expansion unit connected to the computer if the processing is performed in accordance with instructions from the program code that has been read out of the storage medium and written into memory on the function expansion card or unit.

As described above, the present invention makes it possible to download and use fonts of a special coding scheme not supported by a printer, without affecting normal operation of the equipment, by displaying the coding schemes supported by the printer and converting the fonts into a coding scheme specified by the user from among them.

Also, the present invention allows the character output apparatus to use fonts it cannot normally use and allows the user to select the fonts to be used. This prevents output characters from being garbled.

Besides, the present invention allows supported character coding schemes to be acquired directly from the character output apparatus, preventing selection errors.

Furthermore, by storing the character coding schemes supported by the character output apparatus, the present invention makes it possible to prevent an unsupported character coding scheme from being selected, eliminate the need for communications procedures for acquiring character coding schemes, and thus reduce processing time.

The present invention is not limited to the above embodiments and various changes and modifications can be made within the spirit and scope of the present invention. Therefore, to appraise the public of the scope of the present invention, the following claims are made.

What is claimed is:

1. A font downloading apparatus for downloading fonts to a character output apparatus, comprising:
a selector for allowing one of character coding schemes supported by the character output apparatus to be selected if the character coding scheme of the fonts cannot be used on the character output apparatus;
a converter for converting the character coding scheme of the fonts into the character coding scheme selected via the selector; and
a downloader for downloading the fonts whose character coding scheme has been converted by the converter onto the character output apparatus.

2. The font downloading apparatus according to claim 1, further comprising: an acquisition unit for acquiring coding schemes supported by the character output apparatus from the character output apparatus; and a determination unit for determining that the character coding scheme of the fonts cannot be used by the character output apparatus if the coding schemes acquired by the acquisition unit do not contain the character coding scheme of the fonts.

3. The font downloading apparatus according to claim 1, further comprising: a storage for storing the type of the character output apparatus and character coding schemes supported by the character output apparatus by associating them with each other; and a determination unit for determining that the character coding scheme of the fonts cannot be used by the character output apparatus if the coding schemes associated with the character output apparatus do not contain the character coding scheme of the fonts.

4. A font downloading method for downloading fonts to a character output apparatus, comprising:
a selection step of allowing one of character coding schemes supported by the character output apparatus to be selected if the character coding scheme of the fonts cannot be used on the character output apparatus;
a conversion step of converting the character coding scheme of the fonts into the character coding scheme selected in the selection step; and
a step of downloading the fonts whose character coding scheme has been converted in the conversion step onto the character output apparatus.

5. The font downloading method according to claim 4, further comprising:
an acquisition step of acquiring coding schemes supported by the character output apparatus from the character output apparatus; and a step of determining that the character coding scheme of the fonts cannot be used by the character output apparatus if the coding schemes acquired in the acquisition step do not contain the character coding scheme of the fonts.

6. The font downloading method according to claim 4, further comprising a step of reading character coding schemes supported by the character output apparatus and stored being associated with the type of the character output apparatus out of storage means and determining that the character coding scheme of the fonts cannot be used by the character output apparatus if the coding schemes associated with the character output apparatus do not contain the character coding scheme of the fonts.

7. A computer program product for downloading fonts to a character output apparatus, comprising:
code for a selection step of allowing one of character coding schemes supported by the character output apparatus to be selected if the character coding scheme of the fonts cannot be used on the character output apparatus;
code for a conversion step of converting the character coding scheme of the fonts into the character coding scheme selected in the selection step; and
code for a step of downloading the fonts whose character coding scheme has been converted in the conversion step onto the character output apparatus.

8. The computer program according to claim 7, further comprising: code for an acquisition step of acquiring coding schemes supported by the character output apparatus from the character output apparatus; and code for a step of determining that the character coding scheme of the fonts cannot be used by the character output apparatus if the coding schemes acquired in the acquisition step do not contain the character coding scheme of the fonts.

9. The computer program according to claim 7, further comprising: code for a storage step of storing the type of the character output apparatus and character coding schemes supported by the character output apparatus by associating them with each other; and code for a step of determining that the character coding scheme of the fonts cannot be used by the character output apparatus if the coding schemes associated with the character output apparatus do not contain the character coding scheme of the fonts.

10. The font downloading apparatus according to claim 1, wherein after being converted by the conversion means, character codes are further converted into printer character codes by the character output apparatus.

11. The font downloading apparatus according to claim 10, wherein, the character codes after conversion by the conversion means are Unicode character codes while the printer character codes are Western European, Cyrillic, or other character codes associated with a language or region.
